(19) United States
(12) Patent Application Publication
(10) Pub. No.: US 2024/0286705 A1
(43) Pub. Date: Aug. 29, 2024

(54) REAR SUSPENSION SYSTEM FOR BICYCLES

(71) Applicant: D'Arcy O'Connor, Victoria (CA)

(72) Inventor: D'Arcy O'Connor, Victoria (CA)

(73) Assignee: D'Arcy O'Connor, Victoria (CA)

(21) Appl. No.: 18/654,705

(22) Filed: May 3, 2024

(51) Int. Cl. B62K 25/28

(52) U.S. Cl. CPC B62K 25/286

(57) ABSTRACT

A bicycle rear wheel suspension system includes a first link and a second link both pivotally attached to the main frame and to a rear stay or swingarm member. A third link is activated by the first or the second link. The third link activates a fourth link. Either the third or the fourth link can be attached to the main frame at one pivot point. One end of the shock absorber is attached to the third or fourth link at another pivot point. The shock absorber has its other end attached to the first or second link that is not receiving said third link. The third and fourth links are responsible for tuning of the suspension rate characteristics, whereas the first and second links are responsible for precisely defining the rear wheel axle trajectory as the suspension system compresses.

### CROSS-REFERENCE TO RELATED APPLICATIONS

This application is related to co-pending U.S. patent Provisional Application No. 63/575,386, filed Apr. 5, 2024, titled “Rear Suspension System for Bicycles”, the disclosure of which is hereby incorporated by reference in its entirety.

### TECHNICAL FIELD

This application relates to an improved rear suspension system to be used generally on two-wheeled vehicles, particularly bicycles both electric, non-electric and motorized, and more specifically to a rear wheel suspension system used on mountain bicycles.

### BACKGROUND OF THE INVENTION

Rear wheel suspension systems have been used on a variety of two-wheeled vehicles, including motorcycles, scooters, and bicycles, with the intended purpose of providing improved rider comfort and increased performance.

Rear wheel suspensions on bicycles have become increasingly popular, and generally provide a rider with the benefits of a more comfortable ride and better control over the bicycle. Such bicycle suspension systems improve ride quality by absorbing the energy incurred from encountering ground obstacles, rather than transmitting them through the frame to the rider. By maintaining greater contact between the tire and the ground, the suspension also provides the rider with better control for accelerating, braking, and cornering.

For a suspension to be suitable for use on a bicycle, it must be efficient. Ideally, a perfect rear wheel suspension would compress only in reaction to ground forces but not to drive-train or braking forces. Unwanted suspension movement resulting from drive train forces wastes rider energy.

Accordingly, there exists a need for an improved bicycle rear wheel suspension which reacts principally to ground forces and limits the action of drivetrain and braking forces thereon. These kinematic qualities require fine-tuning, and the suspension described herein de-couples rear wheel axle movement from the rate at which the rear wheel slows down as the shock absorber is compressed by the suspension. By utilizing a six-bar type suspension which utilizes six linkages that limit the remaining Degrees of Freedom of the movable suspension system to one. This remaining Degree of Freedom is controlled exclusively by the shock absorber. Additional linkages allow the decoupling of the rear wheel trajectory from suspension rate which provides an improvement to suspension quality.

It is therefore the aim of the present invention to provide an improved rear wheel suspension system for a bicycle.

### SUMMARY OF THE INVENTION

In accordance with the present invention, there is provided a bicycle frame set comprising: a main frame including at least a seat tube, a top tube, a head tube, a down tube, and a bottom bracket; and a rear wheel suspension system pivotally attached to the main frame, the rear wheel suspension system comprising: a first link pivotally attached to the main frame at a first pivot point; a rear stay member having an upper end pivotally attached to the first link at a second pivot point and a lower end having a dropout receiving a rear wheel axle of the bicycle, the rear wheel axle defining an axle axis about which the rear wheel rotates when mounted to the dropout; a second link pivotally attached to the main frame at a third pivot point located on said main frame at a lower vertical elevation than the first pivot point, and the second link being pivotally attached to the rear stay member at a fourth pivot point located on said rear stay member below said upper end thereof. An instantaneous center of rotation (ICR), or Virtual Pivot Point (VPP), is defined an at intersection between an upper axis extending through the first and second pivots and a lower axis extending through the third and fourth pivots. It is the precise location of the ICR in relation to the tension side of the chain, in combination with rear wheel trajectory that precisely determines the amount of Anti-squat and resultant pedal kickback (crankset counter-rotation) that the suspension will exhibit.

A third link is activated by either the first or the second link, and in turn activates a fourth linkage. This fourth linkage is attached to the main at seventh frame a pivot point. In one embodiment, the fourth linkage attaches to the rear shock absorber at one of its ends. In an alternate embodiment, it is the third linkage, that attaches the rear shock absorber at one of its ends. For both embodiments the other end of the shock absorber is attached to either the first or second link that is not attached to the third link. The purpose of the third and fourth links is to accurately control the rate at which the rear wheel axle speeds up or slows down as it moves from fully extended to fully compressed suspension positions relative to a fixed incremental amount of shock movement. By decoupling the task of suspension rate adjustment from the task of specifically defining rear wheel trajectory, it is possible to independently adjust these two design parameters independently from each other. When only a first and second set of linkages are used for a vehicle suspension it is not possible to adjust the wheel trajectory independently from the Suspension Rate parameter, thus requiring compromises to be made to either design variable.

### BRIEF DESCRIPTION OF THE DRAWINGS

Reference will now be made to the accompanying drawings, showing by way of illustration a particular embodiment of the present invention and in which:

FIG. 1 is a schematic right-side view of a complete bicycle whose frame includes a rear suspension system in the fully extended state, according to the first embodiment of the present invention;

FIG. 2 is a schematic right-side view of a bicycle frame including a rear suspension system in the fully extended state, according to the first embodiment of the present invention;

FIG. 3 is an isometric view of a bicycle frame including a rear suspension system in the fully extended state, according to the first embodiment of the present invention;

FIG. 4 is a schematic right-side view of a bicycle frame including a rear suspension system in the fully compressed state, according to the first embodiment of the present invention;

FIG. 5 is an isometric view of a bicycle frame including a rear suspension system in the fully compressed state, according to the first embodiment of the present invention;

FIG. 6 is a schematic right-side view of a bicycle frame including a rear suspension system in the fully extended state, according to a second embodiment of the present invention;

FIG. 7 is a schematic right-side view of a bicycle frame including a locus of rear suspension system positions as it moves from the fully extended to the fully compressed state, according to a second embodiment of the present invention;

FIG. 8 is a schematic right-side view of a bicycle frame including a rear suspension system in the fully extended state, according to a third embodiment of the present invention;

FIG. 9 is a schematic right-side view of a bicycle frame including a locus of rear suspension system positions as it moves from the fully extended to the fully compressed state, according to a third embodiment of the present invention;

FIG. 10 is a schematic right-side view of a bicycle frame including a rear suspension system in the fully extended state, according to a fourth embodiment of the present invention;

FIG. 11 is a schematic right-side view of a bicycle frame including a locus of rear suspension system positions as it moves from the fully extended to the fully compressed state, according to a fourth embodiment of the present invention;

FIG. 12 is a schematic right-side view of a bicycle frame including a rear suspension system in the fully extended state, according to a fifth embodiment of the present invention; and

FIG. 13 is a schematic right-side view of a bicycle frame including a locus of rear suspension system positions as it moves from the fully extended to the fully compressed state, according to a fifth embodiment of the present invention.

### DETAILED DESCRIPTION OF THE INVENTION

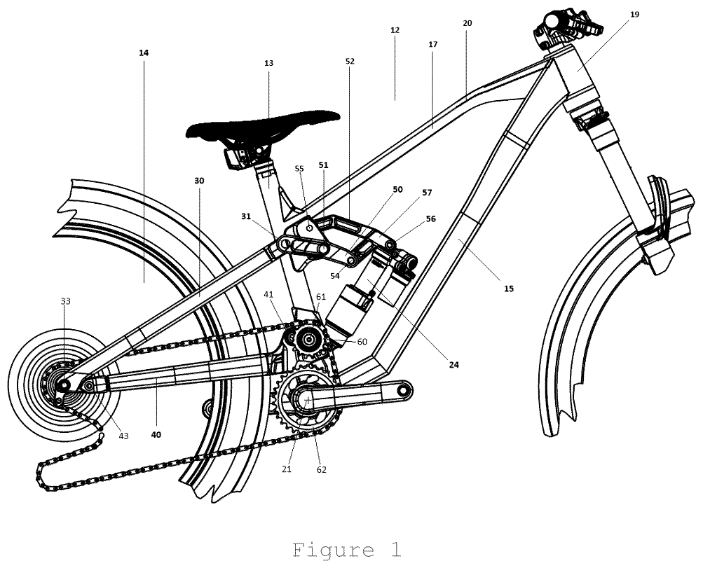

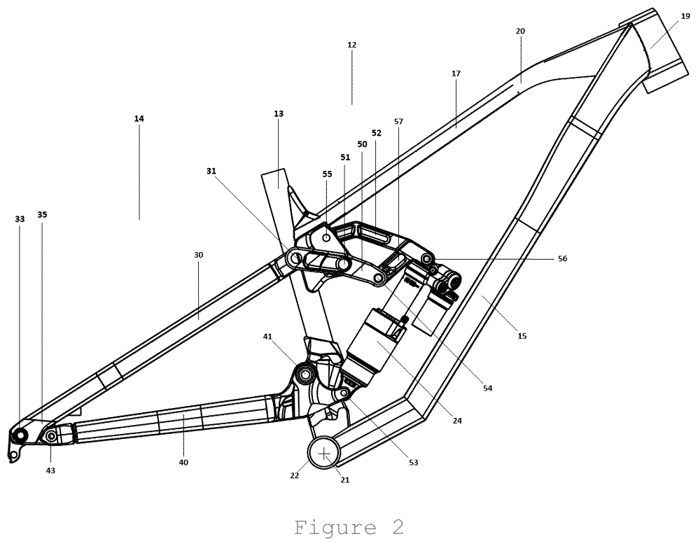

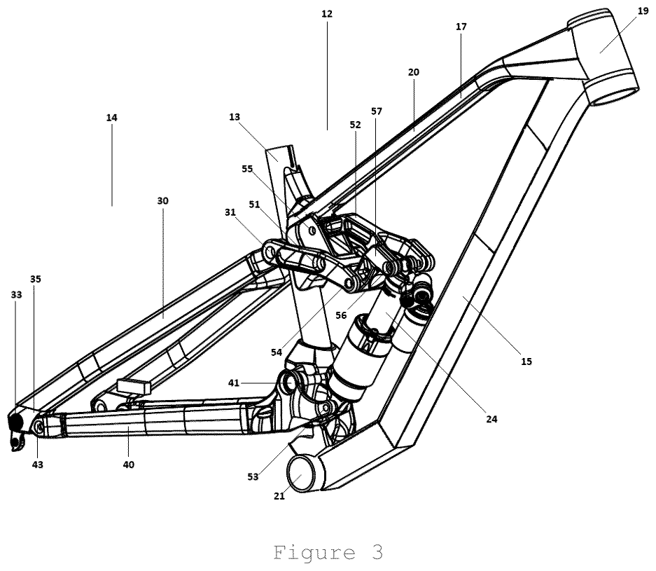

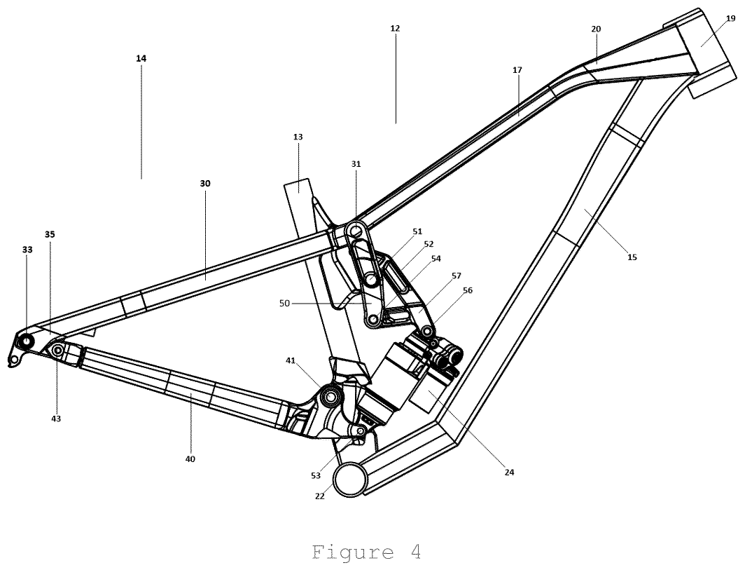

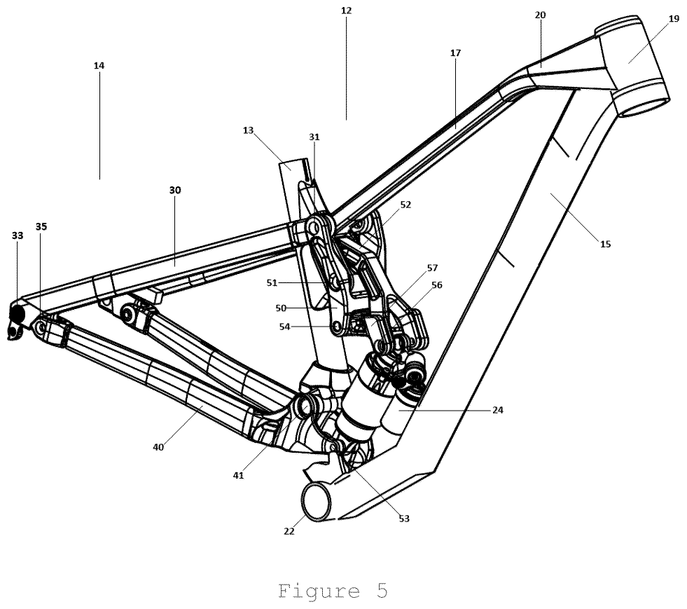

Referring to FIG. 1, FIG. 2, FIG. 3, FIG. 4 and FIG. 5, a complete bicycle and a bicycle frame assembly are shown according to the first embodiment of the present invention is generally shown at 12 and comprises a rear suspension system linkage assembly 14 and a main frame 20. In a particular embodiment, the main frame 20 is manufactured out of aluminum, steel, carbon-fiber, or any other suitable material.

The main frame 20 comprises a seat tube 13, a down tube 15, a top tube 17, a head tube 19 and a bottom bracket 22. The bottom bracket 22 defines a crank axis 21 extending normal to the view orientation, about which the bicycle's pedal cranks rotate.

In an alternate embodiment, the main frame 20 is a single large structure rather than the previously described assembly of distinct tubes, such as a monocoque-type frame section which can be made, for example, of carbon fiber or sheet metal.

A springing and damping mechanism, or shock absorbing member, such as shock absorber 24, is pivotally attached at one of its ends to the fourth link 52 at an eighth pivot point 56. The other end of the shock absorber 24 is attached to second link 40 at the ninth pivot point 53.

The shock absorber 24 acts to counter any forces that may be applied to the rear suspension linkage assembly 14 by the rear wheel as it encounters ground obstacles to tend to maintain the relative positions of the main frame 20, the sprung mass, relative to the ground. Doing so thereby also tends to attempt to keep the rear wheel in substantially continuous contact with the ground thereby affording the rider greater control of the vehicle than would occur if the rear wheel is permitted to leave contact with the ground for significant periods of time. Having the rear wheel out of contact with the ground results in a significant decrease in the rider's ability to exert control over the vehicle, caused by a loss in traction with the ground and unnecessary movement of the sprung mass. By doing so, the shock absorber 24 absorbs much of the energy which enters the vehicle through the rear wheel rather than having that energy transferred through the main frame 20 to the rider. As a result, the rider experiences a more comfortable ride and can maintain better control over the vehicle. This is of particular significance when the vehicle is operated over highly uneven terrain such as what commonly takes place in the operation of mountain bicycles.

The linkage assembly 14 includes a first link member 50, a pair of second link members 40, and a pair of rear stay members 30. The rear wheel of the bicycle is mounted between the pair of rear stay members 30 at dropouts 35 provided at the lower ends thereof. Hence, the rear wheel's axle, and, therefore, the rear wheel's central axis 33, is mounted within the dropouts 35.

The rear ends of the second link members 40 are pivotally connected to the rear stay members 30 at fourth pivot point 43, and the front ends of the second link members 40 are pivotally connected to the main frame 20 at a third pivot point 41. The third pivot point 41 is located substantially above, not proximate to the crank axis 21, and the fourth pivot point 43 is located proximate to the rear wheel's axis 33. In some cases, the fourth pivot point 43 can be eliminated and replaced with a “flexible pivot” which is engineered to bend the rigid structure, thus behaving as if it was an actual pivot point. In some cases, the fourth pivot point can be co-axial with rear wheel's central axis 33.

One end of the first link member 50 is pivotally connected to the top of the rear stay members 30 at a second pivot point 31. The first link member 50 is further pivotally connected at first pivot point 51 that is attached either to the top tube 17, the seat tube 13, or to both. The first pivot point 51 is substantially higher on the main frame 20 than is the third pivot point 41 of the second link member 40. Additionally, cantilevered beyond the first pivot point 51 of the first link member 50 is a fifth pivot point 54 that connects said linkage member to a third link member 57. A fourth link member 52 is acted on by the third link 57 at a sixth pivot point located at its end 56 or a point proximate to the end that is located along the length of the fourth link member 52. The fourth link member 52 is pivotally attached to the main frame 20 at a seventh pivot point 55, which can be affixed to the top tube 17, the seat tube 13, or to both. The shock absorber 24 is attached at its upper end to the fourth link member 52 at an eighth pivot point 56, which in these figures is shown to be co-axial with the sixth pivot point. In an alternate embodiment, the sixth pivot point and the eighth pivot point may not be co-axial. The shock absorber 24 is attached at its lower end at a ninth pivot point 53 which is structurally attached proximate to the third pivot point 41 of the second link member 40. Both ends 53 and 56 of the shock absorber move relative to the main frame 20 as the suspension compresses.

In the embodiment shown, two rear stay members 30 and two stay members 40 are provided, one of each type of member being located on a respective side of the vehicle's rear wheel and being generally symmetrical with the other.

Referring to FIG. 1, what is commonly know as a “high pivot” suspension is shown that utilizes an “idler pulley” 60, that directs the chain around its rotating center at a point 61 that is rigidly affixed to the main frame 12 at a location above crank axis 21. It is important to note that the invention described herein also relates to a “low pivot” suspension, where an idler pulley 60 is not utilized, and the chain wraps around the chain ring 62 that rotates around the crank rotating axis 21.

Referring to FIG. 4 and FIG. 5, a bicycle frame assembly according to the first embodiment of the present invention is generally shown at 12. The rear suspension system linkage assembly 14 is shown in these Figures in the fully compressed state. As we can see, the first link 50 is rotated in a clockwise sense from its original position when the shock is fully compressed and thus co-rotates relative to the second link member 40; the first link 50 rotates in the same sense as second link member 40. In another embodiment of the present invention not shown it is possible for the first link member 50 to rotate counter clockwise as the suspension is compressed and thus would rotate in the opposite sense to the second link member 40 as the suspension is compressed.

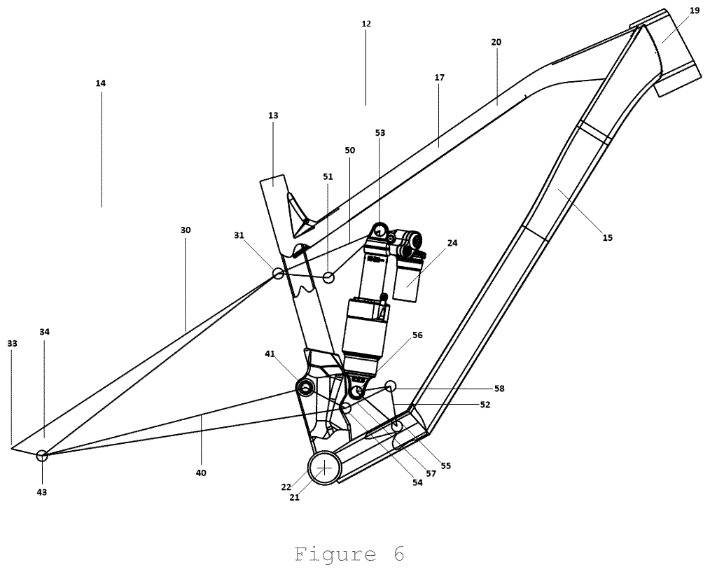

Referring to FIG. 6, a bicycle frame assembly according to a second embodiment of the present invention is generally shown at 12 and comprises a rear suspension system linkage assembly 14 and a main frame 20. In a particular embodiment, the main frame 20 is manufactured out of aluminum, steel, carbon-fiber, or any other suitable material.

The main frame 20 comprises a seat tube 13, a down tube 15, a top tube 17, a head tube 19 and a bottom bracket 22. The bottom bracket 22 defines a crank axis 21 extending normal to the view orientation, about which the bicycle's cranks rotate.

A springing and damping d mechanism, or shock absorbing member, such as shock absorber 24, is mounted to the first link member 50 at a ninth pivot point 53. The shock absorber 24 provides a compression resistance force against which the rear suspension system linkage assembly 14 operates.

The linkage assembly 14 includes a first link member 50, a pair of second link members 40, and a pair of rear stay members 30. The rear wheel of the bicycle is mounted between the pair of rear stay members 30 at dropouts 35 provided at the lower ends thereof. Hence, the rear wheel's axle, and, therefore, the rear wheel's central axis 33, is mounted within the dropouts 35.

The front ends of the second link members 40 are pivotally connected to the main frame 20 at a third pivot point 41 and the rear ends of the second link members 40 are pivotally connected to the rear stay members 30 at a fourth pivot point 43. The third pivot point 41 is located substantially above the crank axis 21, and the fourth pivot point 43 is located proximate to the rear wheel's axis 33. In some cases, pivot point 43 can be eliminated and replaced with a “flexible pivot” which is engineered to bend the rigid structure, thus behaving as if it was an actual pivot point. In other cases, the fourth pivot point 43 may also be co-axial with the wheel central axis 33.

One end of the first link member 50 is pivotally connected to the top of the rear stay members 30 at a second pivot point 31. The first link member 50 is further pivotally connected at a first pivot point 51 that is attached to the either the top tube 17, the seat tube 13, or to both. The first pivot point 51 is substantially higher on the main frame 20 than is the third pivot point 41 of the second link member 40. The third link 57 is attached pivotally to the second link member 40 at a fifth pivot point 54. The other end of the third link member 57 is pivotally attached to the fourth link member 52 at a sixth pivot point 58. The third link member 57 activates the fourth link member 52 as the suspension compresses and can either be in tension or compression as the suspension is compressed providing that the fifth pivot point 54 is located above or below the third pivot point 41. In this embodiment of the present invention the fourth link member 52 is pivotally connected to the main frame 20 at a seventh pivot point 55, which can be affixed to either the downtube 15 or the seat tube 13, or to both. The lower end of the shock absorber 24 is pivotally attached to the fourth link member 52 at an eighth pivot point 56. In this embodiment of the present invention, the eighth pivot point 56 and the sixth pivot point 58 are not co-axial and the eighth pivot point 56 is a part of the fourth linkage member 52. Both ends 53 and 56 of the shock absorber 24 move relative to the main frame 20 as the suspension compresses.

In the embodiment shown, two rear stay members 30 and two stay members 40 are provided, one of each type of member being located on a respective side of the vehicle's rear wheel and being generally symmetrical with the other.

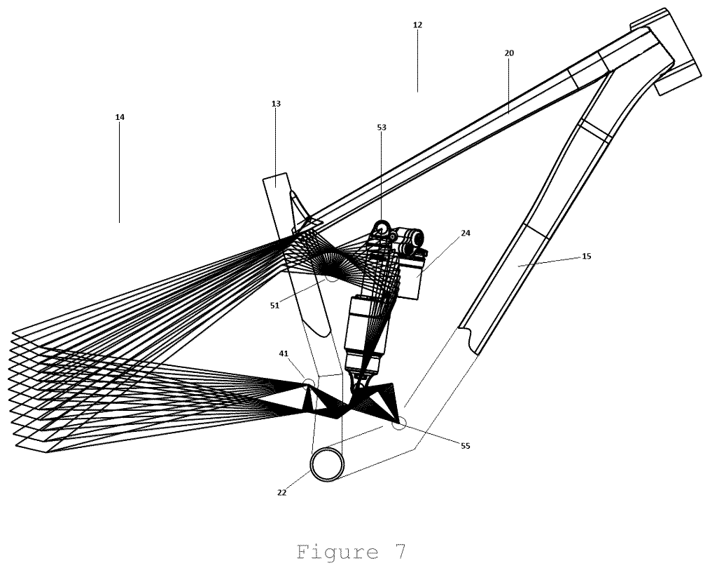

Referring to FIG. 7, a locus of suspension linkage 14 positions is shown at a fixed incremental shock stroke from its fully extended to fully compressed state for the second embodiment of the present invention.

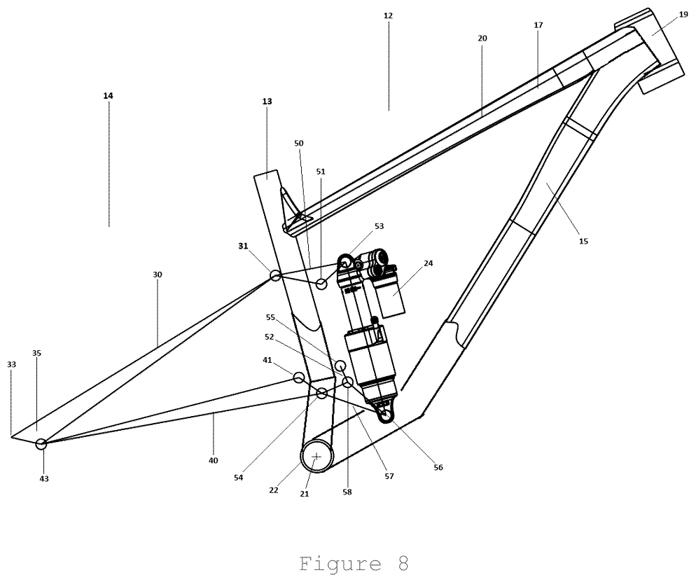

Referring to FIG. 8, a bicycle frame assembly according to a third embodiment of the present invention is generally shown at 12 and comprises a rear suspension system linkage assembly 14 and a main frame 20. In a particular embodiment, the main frame 20 is manufactured out of aluminum, steel, carbon-fiber, or any other suitable material.

The main frame 20 comprises a seat tube 13, a down tube 15, a top tube 17, a head tube 19 and a bottom bracket 22. The bottom bracket 22 defines a crank axis 21 extending normal to the view orientation, about which the bicycle's cranks rotate.

A springing and damping mechanism, or shock absorbing member, such as shock absorber 24, is mounted to the first link member 50 at a ninth pivot point 53. The shock absorber 24 provides a compression resistance force against which the rear suspension system linkage assembly 14 operates.

The linkage assembly 14 includes a first link member 50, a pair of second link members 40, and a pair of rear stay members 30. The rear wheel of the bicycle is mounted between the pair of rear stay members 30 at dropouts 35 provided at the lower ends thereof. Hence, the rear wheel's axle, and, therefore, the rear wheel's central axis 33, is mounted within the dropouts 35.

The front ends of the second link members 40 are pivotally connected to the main frame 20 at a third pivot point 41 and the rear ends of the second link members 40 are pivotally connected to the rear stay members 30 at a fourth pivot point 43. The third pivot point 41 is located substantially above the crank axis 21, and the fourth pivot point 43 is located proximate to the rear wheel's axis 33.

One end of the first link member 50 is pivotally connected to the top of the rear stay members 30 at a second pivot point 31. The first link member 50 is further pivotally connected at a first pivot point 51 that is attached to the either the top tube 17, the seat tube 13, or to both. The first pivot point 51 is substantially higher on the main frame 20 than is the third pivot point 41 of the second link member 40. The third link 57 is attached pivotally to the second link member 40 at a fifth pivot point 54. Another end of the third link member 57 is pivotally attached to the fourth link member 52 at a sixth pivot point 58. The fourth link member 52 is pivotally attached to the main frame 20 at a seventh pivot point 55, which can be mounted to the seat tube 13. The lower end of the shock absorbing member 24 is pivotally attached to the third link member 57 at an eighth pivot point 56. Both ends 53 and 56 of the shock absorber 24 move relative to the main frame 20 as the suspension compresses.

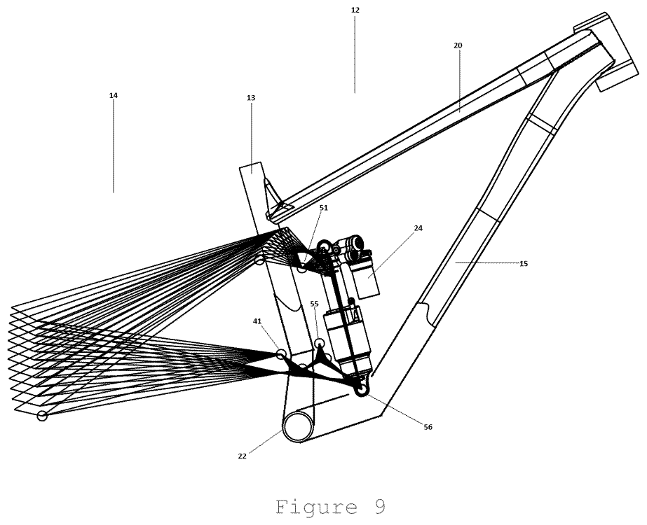

Referring to FIG. 9, a locus of suspension linkage 14 positions is shown at a fixed incremental shock stroke from its fully extended to fully compressed state for the third embodiment of the present invention.

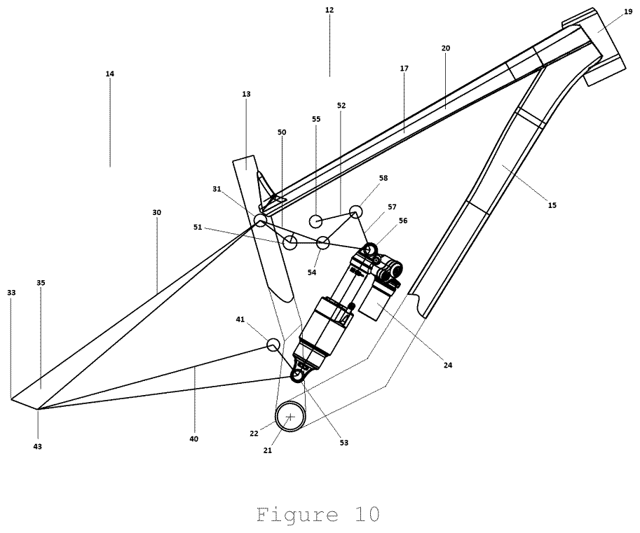

Referring to FIG. 10, a bicycle frame assembly according to a fourth embodiment of the present invention is generally shown at 12 and comprises a rear suspension system linkage assembly 14 and a main frame 20. In a particular embodiment, the main frame 20 is manufactured out of aluminum, steel, carbon-fiber, or any other suitable material.

The main frame 20 comprises a seat tube 13, a down tube 15, a top tube 17, a head tube 19 and a bottom bracket 22. The bottom bracket 22 defines a crank axis 21 extending normal to the view orientation, about which the bicycle's pedal cranks rotate.

A springing and damping mechanism, or shock absorbing member, such as shock absorber 24, is mounted to the second link member 40 at a ninth pivot point 53. The shock absorber 24 provides a compression resistance force against which the rear suspension system linkage assembly 14 operates.

The linkage assembly 14 includes a first link member 50, a pair of second link members 40, and a pair of rear stay members 30. The rear wheel of the bicycle is mounted between the pair of rear stay members 30 at dropouts 35 provided at the lower ends thereof. Hence, the rear wheel's axle, and, therefore, the rear wheel's central axis 33, is mounted within the dropouts 35.

The front ends of the second link members 40 are pivotally connected to the main frame 20 at a third pivot point 41 and the rear ends of the second link members 40 are pivotally connected to the rear stay members 30 at a fourth pivot point 43. The third pivot point 41 is located substantially above the crank axis 21, and the fourth pivot point 43 is located proximate to the rear wheel's axis 33.

One end of the first link member 50 is pivotally connected to the top of the rear stay members 30 at a second pivot point 31. The first link member 50 is further pivotally connected at the first pivot point 51 that is attached to the either the top tube 17, the seat tube 13, or to both. The first pivot point 51 is located substantially higher on the main frame 20 than is the third pivot point 41 of the second link member 40. The third link 57 is attached pivotally to the first link member 50 at a fifth pivot point 54. Another end of the third link member 57 is pivotally attached to the fourth link member 52 at a sixth pivot point 58. The fourth link member 52 is pivotally attached to the main frame 20 at a seventh pivot point 55, which can be mounted to either the top tube 17, the seat tube 13, or to both. The upper end of the shock absorbing member 24 is pivotally attached to the third link member 57 at an eighth pivot point 56. Both ends 53 and 56 of the shock absorber 24 move relative to the main frame 20 as the suspension compresses.

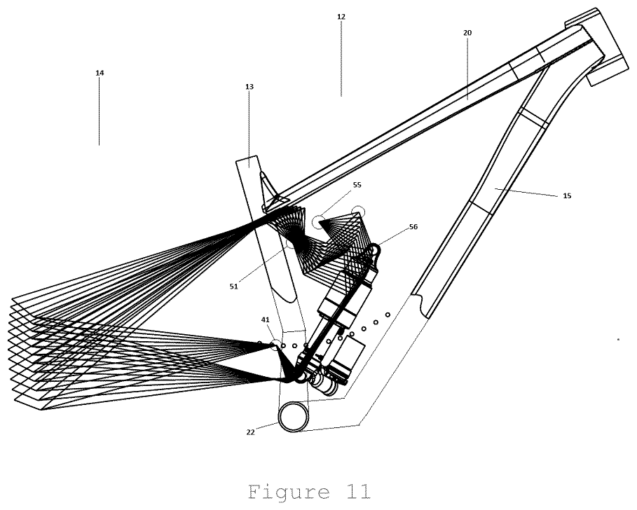

Referring to FIG. 11, a locus of suspension linkage 14 positions is shown at a fixed incremental shock stroke from its fully extended to fully compressed state for the fourth embodiment of the present invention.

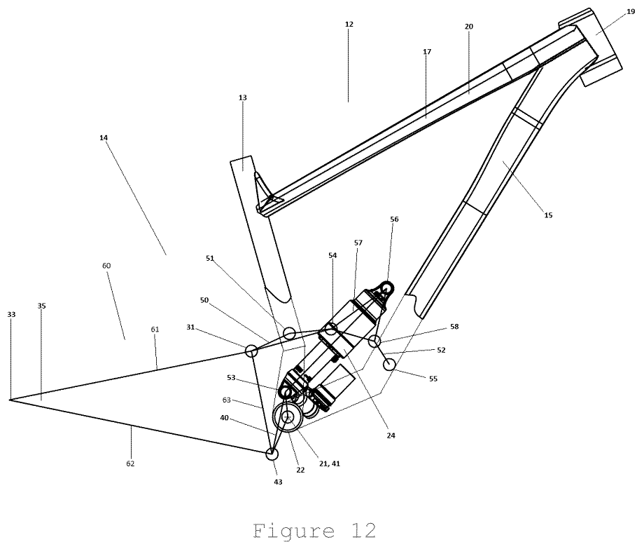

Referring to FIG. 12, a bicycle frame assembly according to a fifth embodiment of the present invention is generally shown at 12 and comprises a rear suspension system linkage assembly 14 and a main frame 20. In a particular embodiment, the main frame 20 is manufactured out of aluminum, steel, carbon-fiber, or any other suitable material.

The main frame 20 comprises a seat tube 13, a down tube 15, a top tube 17, a head tube 19 and a bottom bracket 22. The bottom bracket 22 defines a crank axis 21 extending normal to the view orientation, about which the bicycle's pedal cranks rotate.

A springing and damping mechanism, or shock absorbing member, such as shock absorber 24, is mounted to the second link member 40 at a ninth pivot point 53. The shock absorber 24 provides a compression resistance force against which the rear suspension system linkage assembly 14 operates.

The linkage assembly 14 includes a first link member 50, a second link member 40, and a swingarm shown generally at 60. The swingarm consists of a set of seat stay members 61, a set of chain stay members 62 and a vertical support member 63. The rear wheel of the bicycle is mounted between the pair of seat stay members 61, chain stay members 62 and dropouts 35 provided at the rearward ends thereof. Hence, the rear wheel's axle, and, therefore, the rear wheel's central axis 33, is mounted within the dropouts 35.

The second link member 40 is pivotally connected to the main frame 20 at a third pivot point 41 and one end of the second link member 40 is pivotally connected to the swingarm 60 at a fourth pivot point 43. In this embodiment, the crank axis 21 and third pivot point 41 are coaxial. The fourth pivot point 43 is located proximate crank axis 21.

One end of the first link member 50 is pivotally connected to the swingarm 60 at a second pivot point 31. The first link member 50 is further pivotally connected at the first pivot point 51 that is attached to the seat tube 13. The first pivot point 51 is higher on the main frame 20 than is the third pivot point 41 of the second link member 40. The third link member 57 is pivotally attached to the first link member 50 at a fifth pivot point 54. Another end of the third link member 57 is pivotally attached to the fourth link member 52 at a sixth pivot point 58. The fourth link member 52 is pivotally attached to the main frame 20 at a seventh pivot point 55, which can be mounted to the down tube 15. The upper end of the shock absorbing member 24 is pivotally attached to the third link member 57 at an eighth pivot point 56. Both ends 53 and 56 of the shock absorber 24 move relative to the main frame 20 as the suspension compresses.

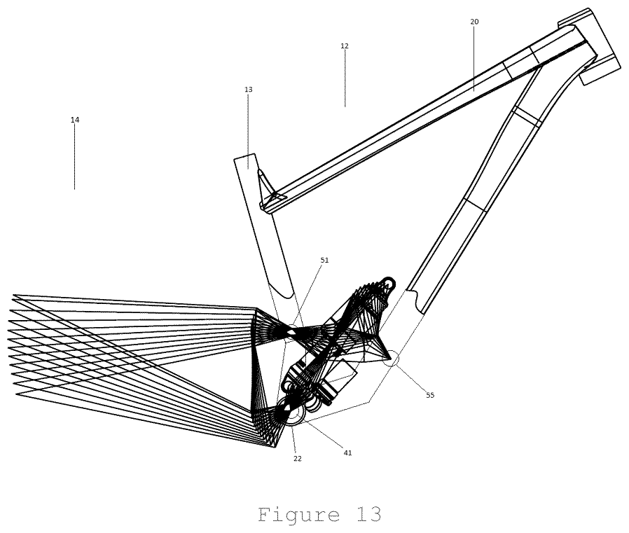

Referring to FIG. 13, a locus of suspension linkage 14 positions is shown at a fixed incremental shock stroke from its fully extended to fully compressed state for the fifth embodiment of the present invention.

The embodiments of the invention described above are intended to be exemplary. Those skilled in the art will therefore appreciate that the foregoing description is illustrative only, and that various alternate configurations and modifications can be devised without departing from the spirit of the present invention. Accordingly, the present invention is intended to embrace all such alternate configurations, such as a non-virtual pivot suspension (a “single pivot” suspension), or modifications and variances which fall within the scope of the appended claims.

The invention as claimed is:

1. A bicycle frame set comprising: a main frame including at least a seat tube, a top tube, a head tube, a down tube, and a bottom bracket; and a rear wheel suspension system pivotally attached to the main frame, the rear wheel suspension system comprising:
a first link pivotally attached to the main frame at a first pivot point; a rear stay member having an upper end pivotally attached to the first link at a second pivot point and a lower end having a dropout receiving a rear wheel axle of the bicycle, the rear wheel axle defining an axle axis about which the rear wheel rotates when mounted to the dropout; and
a second link pivotally attached to the main frame at a third pivot point, located on said main frame at a lower vertical elevation than the first-pivot point, and the second link being pivotally attached to the rear stay member at a fourth pivot point located on said rear stay member below said upper end thereof.

2. A bicycle assembly as described in claim 1 plus a third link that is attached to the first link at a fifth pivot point that is proximate to the first pivot point; the other end of the third link is attached at one end of the fourth link at a sixth pivot point.

3. A bicycle assembly as described in claim 1 plus a third link that is attached to the first link at a fifth point that is proximate to the first pivot point; the other end of the third link is attached proximate to one end of a sixth pivot point.

4. A bicycle assembly as described by claim 2 wherein the fourth link is attached at one of its ends to the main frame at a seventh pivot point. One end of the shock absorber is attached to the fourth link at an eighth pivot point that is located at the other end of the fourth link. In this case, the eighth pivot point and the sixth pivot point are co-axial. The other end of the shock absorber is attached to the second link member at a ninth pivot point that is proximate to the third pivot point.

5. A bicycle assembly as described by claim 3 wherein the fourth link is attached at one of its ends to the main frame at a seventh pivot point. The shock absorber is attached to the fourth link at an eighth pivot point that is located at another end of the fourth link. In this case, the eighth pivot point and the sixth pivot point are not co-axial. The other end of the shock absorber is attached to the second link member at a ninth pivot point that is proximate to the third pivot point.

6. A bicycle assembly as described in claim 1 plus a third link that is attached to the second link at a fifth pivot point that is proximate to the third pivot point; the third link is additionally attached at another end of the fourth link at a sixth pivot point.

7. A bicycle assembly as described in claim 1 plus a third link that is attached to the second link at a fifth point that is proximate to the third pivot point; the third link is additionally attached proximate to one end of the fourth link at a sixth pivot point.

8. A bicycle assembly as described by claim 6 wherein the fourth link is attached at one of its ends to the main frame at a seventh pivot point. The shock absorber is attached to the fourth link at an eighth pivot point that is located at the other end of the fourth link. In this case, the eighth pivot point and the sixth pivot point are co-axial. The other end of the shock absorber is attached to the first link member at a ninth pivot point that is proximate to the first pivot point.

9. A bicycle assembly as described by claim 7 wherein the fourth link is attached at one of its ends to the main frame at a seventh pivot point. The shock absorber is attached to the fourth link at an eighth pivot point that is located at another end of the fourth link. In this case, the eighth pivot point and the sixth pivot point are not co-axial. The other end of the shock absorber is attached to the first link member at a ninth pivot point that is proximate to the first pivot point.

10. A bicycle assembly as described in claim 1 plus a third link that is attached to the second link at a fifth pivot point that is proximate to the third pivot point; the third link is additionally attached at another one of its ends to a fourth link at a sixth pivot point.

11. A bicycle assembly as described by claim 10 wherein the fourth link is attached at one of its ends to the main frame at a seventh pivot point. The shock absorber is attached at another end of the third link at an eighth pivot point. In this case, the sixth and the eighth pivot point are not co-axial. The other end of the shock absorber is attached to the first link member at a ninth pivot point that is proximate to the first pivot point.

12. A bicycle assembly as described in claim 1 plus a third link that is attached to the first link at a fifth pivot point that is proximate to the first pivot point; the third link is additionally attached at another one of its ends to a fourth link at a sixth pivot point.

13. A bicycle assembly as described by claim 12 wherein the fourth link is attached at one of its ends to the main frame at a seventh pivot point. The shock absorber is attached at another one of its ends to the third link at an eighth pivot point. The other end of the shock absorber is attached to the second link member at a ninth pivot point that is proximate to the third pivot point.

14. A bicycle frame set comprising: a main frame including at least a seat tube, a top tube, a head tube, a down tube, and a bottom bracket; and a rear wheel suspension system pivotally attached to the main frame, the rear wheel suspension system comprising:
a first link pivotally attached to the main frame at a first pivot point; a rigid swingarm member comprising a set of chain stays, seat stays, a vertical support tube member and a set of dropouts receiving a rear wheel axle of the bicycle, the rear wheel axle defining an axle axis about which the rear wheel rotates when mounted to the dropout; an upper end of said swingarm being pivotally attached to the first link at a second pivot point and a rearward end having a dropout;
a second link pivotally attached to the main frame at a third pivot point, located on said main frame at a lower vertical elevation than the first-pivot point and is co-axial with the bicycle crank rotating axis; the second link being pivotally attached to the swingarm at a fourth pivot point located below said second pivot point.

15. A bicycle assembly as described in claim 14 plus a third link that is attached to the first link at a fifth pivot point that is proximate to the first pivot point; another end of the third link is attached to a fourth link at a sixth pivot point.

16. A bicycle assembly as described by claim 16 wherein the fourth link is attached at another one of its ends to the main frame at a seventh pivot point. One end of the shock absorber is attached at another end of the third link at an eighth pivot point. The other end of the shock absorber is attached to the second link member at a ninth pivot point that is proximate to the third pivot point.

17. A bicycle frame set comprising: a main frame including at least a seat tube, a top tube, a head tube, a down tube, and a bottom bracket; and a rear wheel suspension system pivotally attached to the main frame, the rear wheel suspension system comprising:
a first link pivotally attached to the main frame at a first pivot point; a rigid swingarm member comprising a set of chain stays, seat stays, a vertical support tube member and a set of dropouts receiving a rear wheel axle of the bicycle, the rear wheel axle defining an axle axis about which the rear wheel rotates when mounted to the dropout; an upper end of said swingarm being pivotally attached to the first link at a second pivot point and a rearward end having a dropout;
a second link pivotally attached to the main frame at a third pivot point, located on said main frame at a lower vertical elevation than the first-pivot point and is located proximate to the bicycle crank rotating axis; the second link being pivotally attached to the swingarm at a fourth pivot point located below said second pivot point.

18. A bicycle assembly as described in claim 17 plus a third link that is attached to the first link at a fifth pivot point that is proximate to the first pivot point; another end of the third link is attached to a fourth link at a sixth pivot point.

19. A bicycle assembly as described by claim 18 wherein the fourth link is attached at another one of its ends to the main frame at a seventh pivot point. One end of the shock absorber is attached at another end of the third link at an eighth pivot point. The other end of the shock absorber is attached to the second link member at a ninth pivot point that is proximate to the third pivot point.
